(19) United States
(12) Patent Application Publication
(10) Pub. No.: US 2016/0271613 A1
(43) Pub. Date: Sep. 22, 2016

(54) MOLDED PLASTIC NEEDLE STICK ACCIDENT PREVENTION DISPENSER

(71) Applicant: Biomedical Polymers, Inc., Gardner, MA (US)

(72) Inventor: Wayne Miller, West Townsend, MA (US)

(73) Assignee: Biomedical Polymers, Inc.

(21) Appl. No.: 14/662,699

(22) Filed: Mar. 19, 2015

(51) Int. Cl. B01L 9/06; B65D 51/22

(52) U.S. Cl. CPC B01L 9/06; B65D 51/22; B01L 2200/085; B01L 2200/141; B01L 2300/0672; B01L 2300/0803; B01L 2300/12

(57) ABSTRACT

A molded plastic dispenser includes a disk and a skirt extending upwards from the disk defining a receptacle for receiving a test tube stopper therein. A spike tube extends from the disk into the receptacle and includes a distal sharpened end and a seat between the disk and the distal sharpened end for engaging the stopper. The skirt has a top rim disposed above the distal sharpened end of the spike tube.

### FIELD OF THE INVENTION

This invention relates to a blood dispenser for transferring blood from a stoppered test tube to a slide or blood analyzer cartridge.

### BACKGROUND OF THE INVENTION

Various dispensers have been designed to transfer blood and other biological fluids from a stoppered test tube to a slide. Most dispensers have some kind of a base and a cannula extending outwardly therefrom. U.S. Pat. Nos. 5,697,522 and 5,344,666, both incorporated herein by this reference, disclose bases with a plurality of stabilizing legs. U.S. Pat. No. 5,163,583, also incorporated herein by this reference, discloses a different design with a skirt about the cannula which is supported by a solid disk. See also the Helena Laboratory Corp's. “H-Pette” products.

The state of the art in blood analyzers includes a cartridge with a blood entry port. A dispenser is used to transfer one or two drops of blood from a stoppered test tube to the cartridge via the blood entry port thereof. The cartridge is loaded into a hand held blood analyzer. See, for example the Abbott “i-STAT” blood analyzer system and U.S. Pat. Nos. 5,096,669; 7,419,821; 6,750,053; and 5,447,440 incorporated herein by this reference.

Conventional dispensers can be awkward to use with such systems. For example, the “C-pette” dispenser has a dispensing tip below a round disk with a flat bottom. When used in connection with the “i-STAT” cartridges, the dispensing tip doesn't go very far into the blood entry port of the cartridge and the round disk does not seat on the cartridge.

When handling blood, communication of blood borne pathogens is a concern. Thus, U.S. Pat. No. 5,163,583 discloses a dispenser which is designed to prevent splashing, spraying, or spattering of blood. The patent discloses a dispenser with a skirt surrounding a spike tube with a sharp penetrating end of the spike tube shown in FIGS. 3-5 to be located at the top of the skirt when the stopper resides on the inside of the circular disk portion. After use, a danger exists in that a nurse or technician could be pierced by the sharp end of the spike tube. Blood borne pathogens such as the Aids or the Ebola virus could be thus transferred to the nurse or technician.

### SUMMARY OF THE INVENTION

In aspects of the invention, the sharp end of the spike tube resides below the dispenser skirt to prevent a needle stick accident and to prevent the transfer of blood borne pathogens to a user of the dispenser. The spike tube preferably includes a seat positioning the stopper of the test tube in a spaced relationship above the bottom disk of the dispenser.

Featured is a molded plastic dispenser. A disk has a skirt extending upwards from the disk defining a receptacle for receiving a test tube stopper therein. A spike tube extends from the disk into the receptacle and includes a distal sharpened end and preferably a seat between the disk and the distal sharpened end for engaging the stopper. The skirt may have a top rim disposed above the distal sharpened end of the spike tube. A tapered dispenser tip is positioned in fluid communication with the spike tube and depends downward from the disk.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic cross sectional view showing the use of a dispenser in accordance with U.S. Pat. No. 5,163,583;

FIG. 2A is a schematic three dimensional partial cutaway view showing one embodiment of a new molded plastic dispenser in accordance with the invention being positioned for piercing the stopper of a test tube;

FIG. 2B is a schematic three dimensional view similar to FIG. 2A showing the spike tube punctured through the stopper;

FIG. 3 is a schematic three dimensional view of the molded plastic dispenser of FIG. 2;

FIG. 4 is a schematic three dimensional side view of the dispenser of FIG. 3; and

FIG. 5 is a schematic three dimensional top view of the dispenser of FIGS. 3-4.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

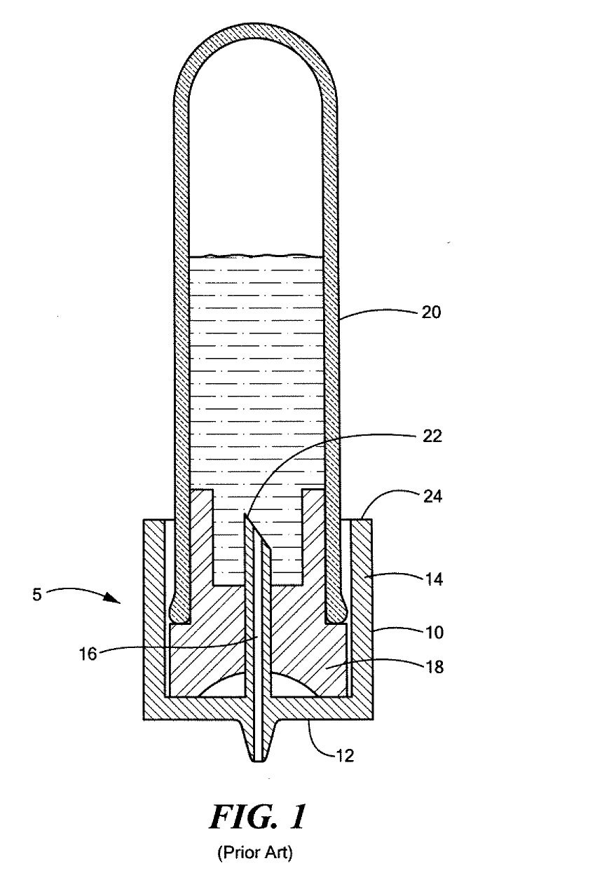

FIG. 1 show the design of the dispensers of U.S. Pat. No. 5,163.583 with body 10 defining disk 12, skirt 14, and spike tube 16 shown pushed through stopper 18 of test tube 20. Spike tube 16 is designed so stopper 18 seats on disk 12. As such, the distal pointed end 22 of spike tube 22 is long enough so it is at or near the plane defined by the top rim 24 of skirt 14. After use, this sharp pointed end 22 of spike tube 16 could cause a stick accident and transfer blood borne pathogens to a nurse or technician.

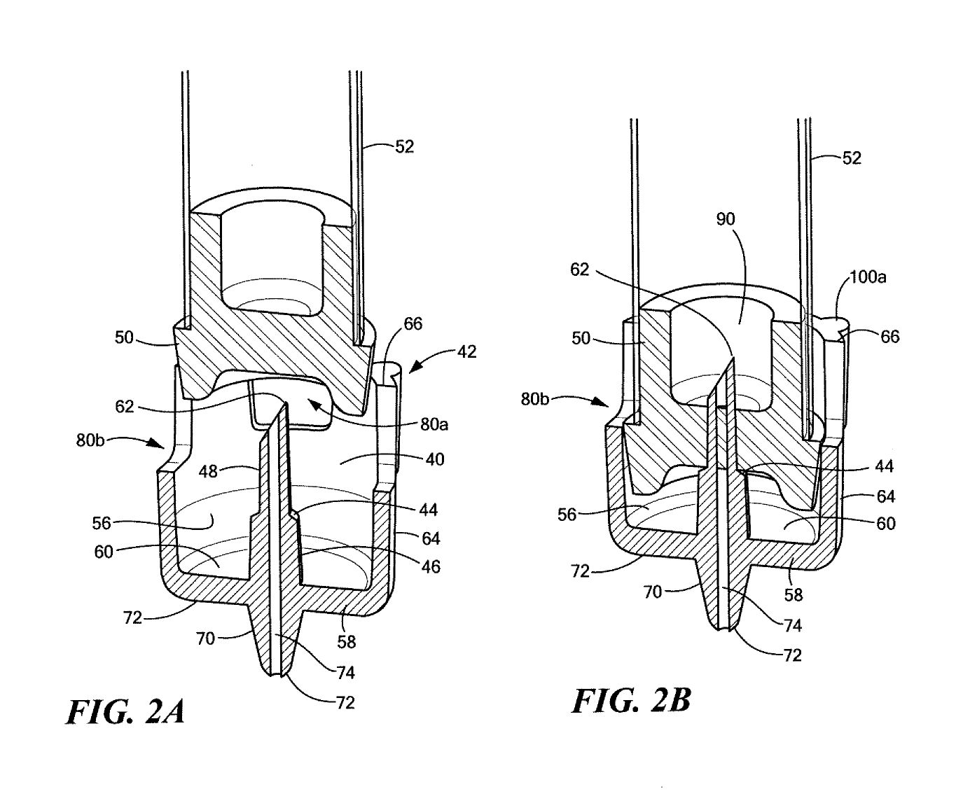

In the new design of FIGS. 2-5, needle stick accidents are prevented. Spike tube 40 of molded plastic dispenser 42 includes a seat 44 where spike tube 40 transitions from a larger diameter at base section 46 to a smaller diameter at shaft section 48. Stopper 50 of test tube 52 thus engages seat 44 as shown in FIG. 2B and positions this particular stopper in receptacle 56 in a spaced relationship above disk 58 interior surface 60. This feature allows for a variety of different size and configurations of stoppers to be used. Seat 44 is located between disk 58 interior surface 60 and sharp distal end 62 of spike tube 40 (e.g., 0.242″ above surface 60). Seat 44 may be angled downwardly as shown. Sharp distal end 62 of spike tube 40 may be disposed 0.65″ above disk surface 60. Skirt 64 extends upward from disk 58 and defines with disk 58 receptacle 56 for receiving the stopper 50 therein.

Side circumferential skirt 64 has top rim 66 configured to be located above distal sharpened end 62 of spike tube 40. Top rim 66 may be .675″ or more above disk 58 inner surface 60. This aspect of the invention serves to protect a user from a needle stick accident or injury since skirt 64 surrounds and is longer than spike tube 40.

Tapered dispenser tip 70 depends downward (e.g., 0.248″) from disk 58 outer surface 72 and tapers to a smaller outer diameter (e.g., 0.074″) at its distal end 72 to be better received in the entry port of a blood analysis system cartridge such as an i-Stat cartridge. Fluid passage 74 extends from the distal end 72 of the dispensing tip 70 to the distal sharp end 62 of spike tube 40.

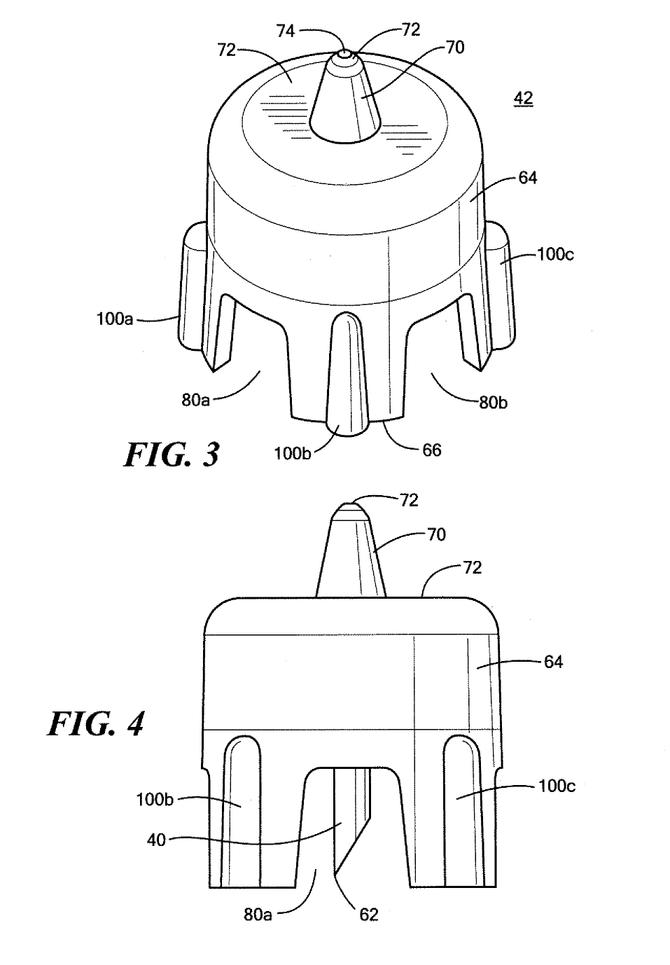

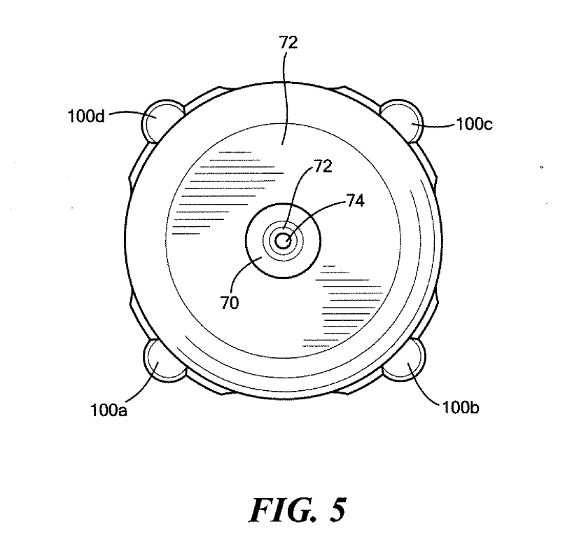

Skirt 64, FIG. 3-4 may include spaced cutouts 80a, 80b as shown in the bottom section thereof for viewing the distal sharpened end of the spike tube as it pierces the stopper so the user can see the distal sharpened end 62, FIG. 2B extending into the interior 90 of the stopper 50 and thus positioned to transfer a fluid (e.g., blood) inside the test tube 52 to dispensing tip 70. Spaced molded ribs 100a, 100b, 100c, and 100d, FIG. 5 may be provided on skirt 64 between the spaced cutout viewing spaces for reinforcement.

The dispenser 42 may be molded out of a suitable medical grade polymer.

In use, the user pushes on the disk outer surface 72, FIG. 2A and/or pushes the test tube to seat stopper 50 within receptacle 56 surrounded by skirt 64 and on seat 44 of spike tube 40 so sharp distal end 62 is now presented to the fluid in test tube 52 to be dispensed to a slide or cartridge via passage 72 and out of tapered distal end 72 of dispensing tip 70.

The interior of the skirt 64 is so dimensioned to seat against the outer periphery of stopper 50. The stopper is spaced above disk 58 and after use and removal from stopper 50 distal pointed end 62 of spike tube 40 is shield by skirt 64 and lies below rim 66 thereof to lower the chances of a user's finger inadvertently being stuck by the spike tube to prevent needle stick injuries.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A molded plastic dispenser comprising:
a disk and a skirt extending upwards from the disk defining a receptacle for receiving a test tube stopper therein;
a spike tube extending from the disk into the receptacle and including a distal sharpened end and a seat between the disk and the distal sharpened end for engaging the stopper;
the skirt having a top rim disposed above the distal sharpened end of the spike tube; and
a tapered dispenser tip in fluid communication with the spike tube and depending downward from the disk.

2. The dispenser of claim 1 in which the skirt includes spaced cutouts defining viewing spaces for the distal sharpened end of the spike tube piercing the stopper.

3. The dispenser of claim 2 further including spaced reinforcing ribs on the skirt between the spaced cutout viewing spaces.

4. A dispenser comprising:
a disk and a skirt extending upwards from the disk defining a receptacle for receiving a test tube stopper therein;
a spike tube extending from the disk into the receptacle and including a distal sharpened end and a seat between the disk and the distal sharpened end for engaging the stopper and positioning the stopper in the receptacle in a position spaced above the disk;
the skirt having a top rim disposed above the distal sharpened end of the spike tube and spaced cutouts defining viewing spaces for the distal sharpened end of the spike tube piercing the stopper;
a tapered dispenser tip in fluid communication with the spike tube and depending downward from the disk; and
the disk, skirt, spike tube, and dispenser tip molded out of a plastic material.

5. The dispenser of claim 4 further including spaced reinforcing ribs on the skirt between the spaced cutout viewing spaces.
